(19) United States
(12) Patent Application Publication
(10) Pub. No.: US 2009/0003329 A1
(43) Pub. Date: Jan. 1, 2009

(54) Repeater, Communication System, Control Circuit, Connector, and Computer Program

(76) Inventors: Koso Murakami, Osaka (JP); Hideki Tode, Osaka (JP); Toshihiro Masaki, Hyogo (JP); Kazuhiko Kinoshita, Osaka (JP)

Correspondence Address: BIRCH STEWART KOLASCH & BIRCH, PO BOX 747, FALLS CHURCH, VA, 22040-0747, US

(21) Appl. No.: 10/588,815

(22) PCT Filed: Feb. 8, 2005
(86) PCT No.: PCT/JP2005/001831

§ 371 Date: Aug. 9, 2006

(30) Foreign Application Priority Data
Feb. 9, 2004 (JP) 2004-032245

(51) Int. Cl. H04L 12/56

(52) U.S. Cl. 370/389

(57) ABSTRACT

A repeater such as an Internet router device used in a communication network such as the Internet. The delay time from a device of a sender to a device of a receiver is secured. A communication system, a control circuit, a connecting means, and a computer program are also disclosed. The sending time intervals between sending to a transmission network are calculated from a target value of the transfer rate of a packet to be relayed (S202), a target value of the delay time is determined on the basis of the delay time to be secured (S205), and a reference value of the storage capacity used as a criterion for deciding discard of a packet is calculated from the delay time target value and the sending time intervals (S206). Packets are sent out at the calculated sending time intervals, and discard of a packet is judged according to a predetermined method when a packet having a storage capacity above the storage capacity reference value is received.

### BACKGROUND OF THE INVENTION

1. Field of the Invention

The present invention relates to a repeater such as an Internet router device receiving a packet through a communication network such as the Internet, determining a route in the communication network to send out the packet, a repeater such as a router device performing routing processing to send out the packet to the communication network on the determined route, a communication system using the repeater, a control circuit controlling the repeater, a connector connected to the repeater, and a computer program for realizing the repeater. Particularly the present invention relates to a repeater guaranteeing QoS in the communication network, the communication system, the control circuit, the connector, and the computer program.

2. Description of Related Art

In recent years, a high performance computer has been widely used not only in research institutes and companies, but also in ordinary houses, and it starts to exhibit a function as new information communication equipment. Therefore, use of a network application such as WWW (World Wide Web) has been drastically increased, and traffic in the communication network such as the Internet and intranet has been exponentially increased. Also, in recent years, along with a spread of a broad band communication, move toward integrating the traffic of voice into the Internet, i.e. VoIP (Voice over IP) has been launched fully. Further, mixing of a stream type traffic that requires a fixed transfer rate such as a video image, and various types of traffics that require different communication qualities such as data transfer with high speed is estimated in the future.

Therefore, in a packet transfer technique through the communication network, a service classification technique such as Diff-Serv (Differentiated Service) and speeding up technique of a packet transfer such as MPLS (Multi-Protocol Label Switching) collect attention as a QoS (Qualities of Service) guaranteeing mechanism that guarantees the communication quality of various types. The Diff-Serv defines a different service class in the traffic having a different attribute, and requires render of service corresponding thereto. Also, the MPLS, which is a speeding-up technique of the packet transfer, realizes a differentiated service for each class, by providing a CoS(Class of Service) in a header of the packet.

As one of the techniques that can be considered for realizing the aforesaid QoS, a scheduling to read buffer is pursued. For example, an input/output buffer type switch wherein the buffer is arranged in an input/output port, respectively solves a problem of constant occupation of a output line by a particular connection, by a discipline of scheduling to read the buffer such as a WFQ (Weighted Fair Queuing) and WRR (Weighted Round Robin). However, packet arrival of high priority traffic in a high load of buffer can not be received by only the aforesaid discipline of scheduling, and a sufficient QoS control can hardly be provided. In addition, it can be fully considered that a plurality of input/output ports are connected as an interface of the router device. In this case, a buffer space is also shared by a plurality of ports. However, a buffer management in consideration of the plurality of ports is not fully studied.

Therefore, in order to realize a high performance router device having a QoS control function for each flow, a buffer management method of performing a priority control for each class by introducing a Pushout mechanism and hierarchically managing it for each port and class is proposed in such a documents as “PER-FLOW BUFFER MANAGEMENT SCHEME WITH CLASS-BASED PRIORITY IN THE INTERNET ROUTER” (IEICE Electronics Society, SSE99-175, IN99-138, issued by IEICE Electronics Society, P. 85-90, in March, 2000). In the method proposed in the aforesaid document, a minimal usable size of buffer can be logically secured for each flow, first. Under an environment of low utilization rate of buffer, use of an actual buffer is allowed despite the aforesaid basic capacity. However, when in a state of a full buffer by transition to a high load environment, the Pushout mechanism is applied and a particular packet is discarded. Further, the above-described document assumes an environment in which one buffer is shared by a plurality of ports. Along with this, such a method is proposed as hierarchically performing the management of the basic capacity in an order of port, class, and flow. Also, the aforesaid document proposes a hierarchical WRR as a discipline of scheduling. Further, the aforesaid document proposes a band distribution method for realizing the priority control by each class.

However, for example, the conventional method shown in the above document involves a problem that although the band distribution method for performing the priority control by each class is proposed, a delay time during packet repeating operation is not guaranteed. Further, the problem is involved such that the delay time from a device of sender to a device of receiver of the packet, which is a high priority issue for a user, is not taken into consideration.

### BRIEF SUMMARY OF THE INVENTION

In view of the above-described circumstances, the present invention is provided, and a main object of the present invention is to provide a repeater capable of calculating a sending time interval, a target value of delay time, and a storage capacity reference value (buffer size) based on a target value of transfer rate of a packet to be relayed, storing the packet received through a communication network in storing means (RAM), and sending out it to the communication network at the time interval thus calculated, to thereby guarantee the delay time during the packet repeating operation, a communication system using the repeater, the control circuit controlling the repeater, a connector connected to the repeater, and a computer program for realizing the repeater.

Further, another object of the present invention is to provide the repeater capable of setting the target value of the delay time by dividing the target value of the delay time from a sender to a receiver of the packet, by the number of devices to be passed through, or setting the target value of the delay time based on the target value of the delay time to the receiver, to thereby perform a control in consideration of the delay time from the device of sender to the device of receiver.

The repeater of a first invention is a repeater for receiving a packet, in which a target value of a transfer rate is shown including divided data obtained by dividing transfer data into a prescribed data length, determining a route in a communication network to send out the packet, storing the packet having a determined route in storing means, and sending out the packet stored in the storing means to the communication network by the determined route at set sending time intervals, and is characterized by comprising: means for calculating the sending time intervals to send out the packet to the communication network, based on the target value of the transfer rate shown in the received packet and the data length of the divided data; means for setting the sending time intervals thus calculated as the sending time intervals of the packet; target value determining means for determining the target value of a delay time required for repeating the packet; means for calculating a reference value of a storage capacity of the packet to be stored in the storing means, based on the delay time target value and the sending time intervals; and means for determining the necessity of discarding the packet, based on the reference value of the storage capacity thus calculated and a capacity of the packet stored in the storing means.

According to the repeater of the present invention, the sending time interval and the storage capacity reference value are calculated based on the transfer rate target value of the packet, and the storage capacity reference value thus calculated is set as the storage capacity value used as a criterion for deciding discard of the packet, and the packet stored in the storing means at the calculated sending time intervals is sent out to the communication network. Thus, the delay time shown by a product of the storage capacity, which becomes the reference value, and the sending time intervals can be guaranteed, and the transfer rate can also be guaranteed accordingly.

The repeater of a second invention according to the first invention is characterized in that the received packet includes total delay time information showing the target value of the delay time from a sender to a receiver, and the target value determining means detects the number of devices to be passed through on the route in the communication network from the sender to the receiver, and determines the target value of the delay time by dividing the time shown by the total delay time information included in the packet by the number thus calculated.

According to the repeater of the present invention, the target value of the delay time is determined based on the number of devices to be passed through during transferring the packet. Thus, the delay time from the device of sender to the device of receiver, i.e. from End to End can be guaranteed.

The repeater of a third invention according to the first invention is characterized in that the received packet includes remaining delay time information showing the target value of the delay time from its own device to the transmission destination, and the target value determining means detects the number of devices to be passed through on the route in the communication network up to the transmission destination, and determines the target value of the delay time by dividing the time shown by the remaining delay time information included in the packet, by the number of the devices thus detected.

According to the repeater of the present invention, the remaining delay time is managed, and based on the remaining delay time, the target value of the delay time is determined. Thus, the setting of the storage capacity reference value and the sending time intervals is dynamically changed in accordance with a delay state from the device of sender to reception by its own device via the communication network, and the delay time can be guaranteed.

The repeater of a fourth invention according to any one of the first invention to third invention is characterized by further comprising: means for detecting the number of discarded packets; and means for changing the setting of the storage capacity reference value and the sending time intervals, when the number of the packets thus detected exceeds a prescribed value.

According to the repeater of the present invention, the setting of the storage capacity reference value and the sending time intervals is dynamically changed in accordance with the number of discarded packets. Thus, even when the capacity of packet to be received is increased by the change of external circumstance such as increase in traffic and the number of discarding the packet is increased to increase the missing of transfer data, the delay time can be guaranteed while the missing of the transfer data is suppressed by reducing the packet to be discarded by changing the storage capacity reference value, specifically by increasing the storage capacity reference value.

A communication system of a fifth invention is a communication system having a transmitter connected to a communication network and transmitting a packet, and a receiver receiving the packet transmitted from the transmitter, and is characterized by comprising the repeater of any one of first through fourth invention, which is connected to the communication network, and repeating the packet transmitted from the transmitter to the receiver.

According to the communication system of the present invention, by constituting it by using the repeater according to any one of the first invention to fourth invention, the delay time from a transmitter to a receiver can be guaranteed.

A control circuit of a sixth invention is a control circuit, used in a repeater for receiving a packet, in which a target value of a transfer rate is shown including divided data obtained by dividing transfer data into a prescribed data length, determining a route in a communication network to send out the packet, and sending out the packet to the communication network by the route thus determined, for storing the packet having a determined route in storing means and sending out it to the communication network, and is characterized by comprising: means for calculating the sending time intervals to send out the packet to the communication network, based on the target value of the transfer rate shown in the received packet and the data length of the divided data; means for setting the sending time intervals thus calculated as the sending time intervals of the packet; means for determining the target value of a delay time required for repeating the packet; means for calculating a reference value of a storage capacity of the packet to be stored in the storing means, based on the delay time target value and the sending time intervals; means for determining the necessity of discarding the packet, based on the reference value of the storage capacity thus calculated and a capacity of the packet stored in the storing means; and means for sending out the packet stored in the storing means from the repeater at set sending time intervals.

According to the control circuit of the present invention, the control circuit is incorporated into the repeater such as a router device having a function to determine a route to send out the packet in the communication network, the sending time intervals and the storage capacity reference value are calculated based on the target value of the transfer rate of the packet having a determined route, the storage capacity reference value thus calculated is set as the storage capacity reference value used as a criterion for deciding discard of the packet, and the packet stored in the storing means is sent out to the communication network at the calculated sending time intervals. Thus, the delay time shown by the product of the storage capacity becoming the reference value and the sending time intervals can be guaranteed, and therefore the transfer rate can also be guaranteed.

A connector of a seventh invention is a connector having a first connecting means connected to a repeater to receive a packet in which a target value of a transfer rate is shown including divided data obtained by dividing transfer data into a prescribed data length, determine a route in a communication network to send out the packet and send out the packet having a determined route, and a second connecting means connected to the communication network, and is characterized by comprising: storing means for storing the packet sent out to the communication network; means for receiving the packet having the determined route from the repeater through the first connecting means; means for calculating sending time intervals at which the packet is sent out to the communication network, based on a target value of the transfer rate shown in the received packet and a data length of divided data; means for setting the sending time intervals thus calculated as the sending time intervals of the packet; means for determining the target value of a delay time required for repeating the packet; means for calculating a reference value of a storage capacity of the packet to be stored in the storing means, based on the delay time target value and the sending time intervals; means for determining the necessity of discarding the packet, based on the reference value of the storage capacity thus calculated and a capacity of the packet stored in the storing means; and means for sending out the packet stored in the storing means from the second connecting means to the communication network by the determined route at the set sending time intervals.

According to the connector of the present invention, the connector is connected to the repeater such as a router device having a function to determine the route to send out the packet in the communication network, the sending time intervals and the storage capacity reference value are calculated based on the target value of the transfer rate of the packet having a determined route, the calculated storage capacity reference value is set as the storage capacity reference value used as a criterion for deciding discard of the packet, and the packet stored in the storing means is sent out to the communication network at the calculated time intervals. Thus, the delay time shown by the product of the storage capacity becoming the reference value and the sending time interval can be guaranteed, and therefore the transfer rate can also be guaranteed.

A computer program of an eighth invention is a computer program for controlling a computer to receive a packet, in which a target value of a transfer rate is shown including divided data obtained by dividing transfer data into a prescribed data length, determine a route in a communication network to send out the packet, store the packet having a determined route in storing means to send out it to the communication network by a computer for sending out the packet to the communication network on the route, and the computer program is characterized by causing the computer to execute the following procedure of calculating time intervals to send out the packet to the communication network, based on the target value of the transfer rate shown in the received packet and the data length of the divided data; setting sending time intervals thus calculated as the sending time intervals of the packet; determining a target value of a delay time required for repeating the packet; calculating a reference value of a storage capacity of the packet stored in the storing means, based on a delay time target value and the sending time intervals; and setting the reference value of the storage capacity thus calculated as the storage capacity reference value, used as a criterion for deciding discard of the packet.

According to the computer program of the present invention, in a computer such as a router device having the function to determine the route to send out the packet in the communication network, by being executed as firmware, for example, the computer is operated as the repeater of the present invention, the sending time intervals and the storage capacity reference value is calculated based on the transfer rate target value of the packet having a determined route, the storage capacity reference value thus calculated is set as the storage capacity reference value used as a criterion for deciding discard of the packet, and the packet stored in the storing means at the calculated time intervals is sent out to the communication network. Thus, the time delay shown by the product of the storage capacity becoming the reference value and the sending time intervals can be guaranteed, and the transfer rate can also be guaranteed accordingly.

According to the repeater, communication system, control circuit, connector and computer program of the present invention, the target value of the transfer rate is read from the packet having a determined route in the communication network to be sent out, the sending time intervals are calculated based on the target value of the transfer rate thus read and a data length of the packet, the target value of the delay time in its own device is determined, the storage capacity reference value becoming a reference value of the storage capacity used as a criterion for deciding discard of the packet is calculated, and the packet stored in the storing means is sent out to the communication network at the calculated sending time intervals. By this structure, since the packet of the storage capacity set as the storage capacity reference value can be sent out at the sending time intervals thus set, an excellent effect can be exerted such that the delay time shown by the product of the storage capacity reference value and the sending time intervals can be guaranteed, the delay time, i.e. bandwidth can be guaranteed particularly for the packet of bandwidth guaranteed type, and the QoS mechanism guaranteeing various types of communication qualities can be realized by differentiating the processing for the packet of bandwidth guaranteed type from the processing for the packet of best-effort type.

In addition, according to the present invention, the number of devices to be passed through during transfer of the packet is detected. Therefore, by dividing a total delay time showing the target value of the delay time from the sender to the receiver by the number of devices thus detected, the target value of the delay time in its own device is determined. By this structure, an excellent effect is exerted such that the delay time from the device of sender to the device of receiver, i.e. from End to End can be guaranteed. It should be noted that the target value of the delay time in its own device may be determined based on the target value of the delay time from its own device to the receiver. By adopting the above-described structure, an excellent effect is exerted such that by dynamically changing the setting of the storage capacity reference value and the sending time intervals in accordance with the delay state from the device of sender to reception by its own device via the communication network, the delay time and the transfer rate can be guaranteed.

Further, according to the present invention, the number of the packets discarded during a prescribed period of time is detected, and when the number of the packets thus detected exceeds a prescribed value, the setting of the storage capacity reference value and the sending time intervals is changed. By this structure, even when the capacity of the packet received is increased by change of an external circumstance such as an increase in traffic, thereby increasing the number of discarding the packet and increasing the missing of the transfer data, by changing the storage capacity reference value, specifically by increasing the storage capacity reference value, an excellent effect is exerted such that the delay time can be guaranteed while the missing of the transfer data is suppressed by reducing the packet to be discarded.

Moreover, according to the present invention, various forms of realizing the aforementioned QoS mechanism can be provided, such as the repeater itself, the control circuit such as a VLSI chip that can be incorporated into the existent router device, the connector that can be connected to an external part of the existent router device, and the computer program that can be read in the existent router device as firmware. Accordingly, an excellent effect is exerted such that the existent router device can be used as the repeater realizing the QoS mechanism of the present invention, and therefore an investment cost can be reduced by utilizing the existent device.

### BRIEF DESCRIPTION OF THE SEVERAL VIEWS OF THE DRAWINGS

FIG. 1 is a block diagram showing a constitution of a communication system in an embodiment 1 of the present invention;

FIG. 2 is a block diagram showing the constitution of a repeater in the embodiment 1 of the present invention;

FIG. 3 is a flowchart showing a packet reception process of the repeater in the embodiment 1 of the present invention;

FIG. 4 is a flowchart showing the packet reception process of the repeater in the embodiment 1 of the present invention;

FIG. 5 is a flowchart showing the packet reception process of the repeater in the embodiment 1 of the present invention:

FIG. 6 is a conceptual view showing a hierarchical management of a packet of the repeater in the embodiment 1 of the present invention;

FIG. 7 is a flowchart showing a calculation process of sending time intervals and a storage capacity reference value of the repeater in the embodiment 1 of the present invention;

FIG. 8 is a flowchart showing the calculation process of the sending time intervals and the storage capacity reference value based on a remaining delay time of the repeater in the embodiment 1 of the present invention;

FIG. 9 is a flowchart showing a setting changing process of the sending time intervals and the storage capacity reference value of the repeater in the embodiment 1 of the present invention;

FIG. 10 is a block diagram showing the constitution of the communication system of the present invention;

FIG. 11 is a block diagram showing the connector and the repeater to which the connector is connected in the embodiment 2 of the present invention;

FIG. 12 is a flowchart showing the packet reception process of the connector in the embodiment 2 of the present invention;

FIG. 13 is a flowchart showing the packet reception process of the connector in the embodiment 2 of the present invention;

FIG. 14 is a flowchart showing the packet reception process of the connector in the embodiment 2 of the present invention;

FIG. 15 is a flowchart showing the calculation process of the sending time intervals and the storage capacity reference value of the connector in the embodiment 2 of the present invention; and

FIG. 16 is a block diagram showing the repeater in an embodiment 3 of the present invention.

### DETAILED DESCRIPTION OF THE PRESENT INVENTION

Hereafter, the present invention will be described in detail based on the drawings showing embodiments thereof.

### Embodiment 1

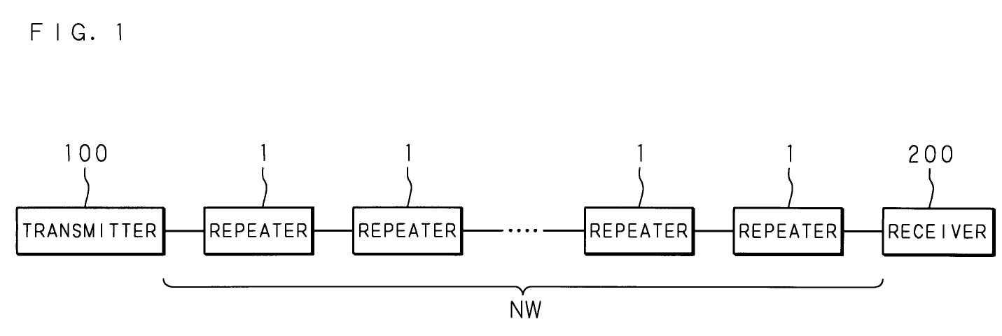

FIG. 1 is a block diagram showing a constitution of a communication system in an embodiment 1 of the present invention. Reference numerals 1, 1, . . . in FIG. 1 denote repeaters of the present invention such as an internet router device. Each repeater 1, 1, . . . is connected to each other by a communication network NW such as the Internet or an intranet. Then, each repeater 1, 1, . . . receives a packet to be transmitted to a receiver 200, which is a device of receiver of the packet, from a transmitter 100, which is a device of sender of the packet, via the communication network NW, determines a route in the communication network NW to transfer the received packet, and performs a route determination process and a packet repeating operation to send out the packet to the communication network NW by the determined route.

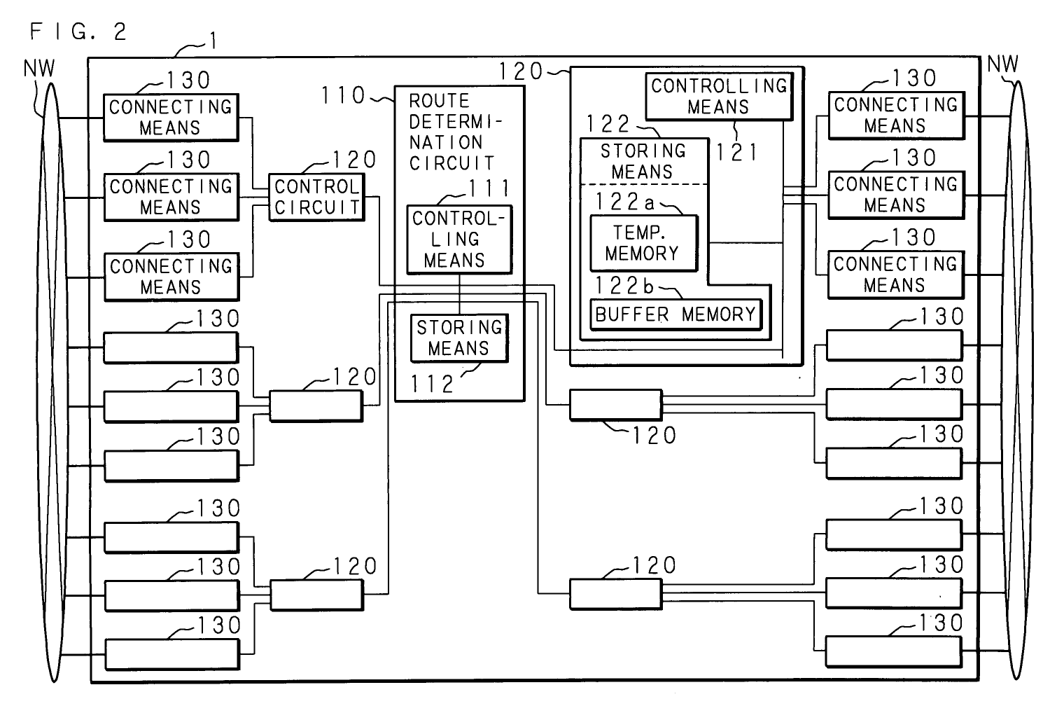

FIG. 2 is a block diagram showing the constitution of the repeater 1 in the embodiment 1 of the present invention. The repeater 1 comprises a route determination circuit 110 such as a switch fabric circuit for determining the route in the communication network NW to send out the packet, a plurality of control circuits 120, 120, . . . according to the present invention for performing a QoS (Quality of Service) control for the packet having a route determined by the route determination circuit 110, and a plurality of connecting means 130, 130, . . . such as input/output ports for performing a transfer of the packet between the control circuit 120 and the communication network NW.

The route determination circuit 110 comprises controlling means 111 such as a CPU and storing means 112 such as a RAM. The route determination circuit 110 temporarily stores the packet received by the connecting means 130 and received through the control circuit 120 in the storing means 112, determines the route in the communication network NW based on transmission destination information such as an IP address showing a receiver 200 shown in a prescribed field provided in a header of the packet, gives the information showing the route thus determined to the packet, and transfers it to an appropriate control circuit 120 in accordance with the route.

The control circuit 120 comprises controlling means 121 such as a CPU and storing means 122 such as a RAM. The control circuit 120 performs such a processing as reading various information including the information showing the route shown in the prescribed field provided in the header of the packet received from the route determination circuit 110, the information showing an attribute related to a transfer rate, the information on a target value of the transfer rate and the target value of a delay time, storing them in the storing means 122 by a method as will be described later based on the information thus read, transferring them to the connecting means 130 and sending them out to the communication network NW by the route based on the information showing the route.

A storage area of the storing means 122 is used as a temporary memory 122a for temporarily storing the packet received from the route determination circuit 110, and a buffer memory 122b for storing the packet temporarily stored in the temporary memory 122a for each flow by a method as will be described later. One buffer memory 122b of one control circuit 120 is commonly shared in storing each packet sent out by each of the plural connecting means 130, 130, . . . connected to one control circuit 120.

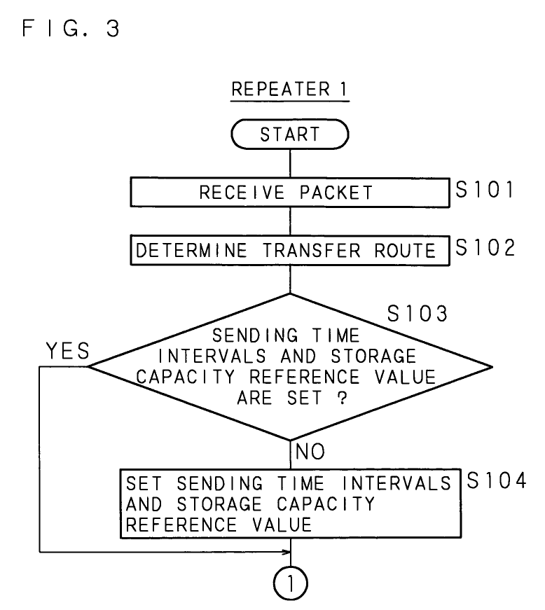

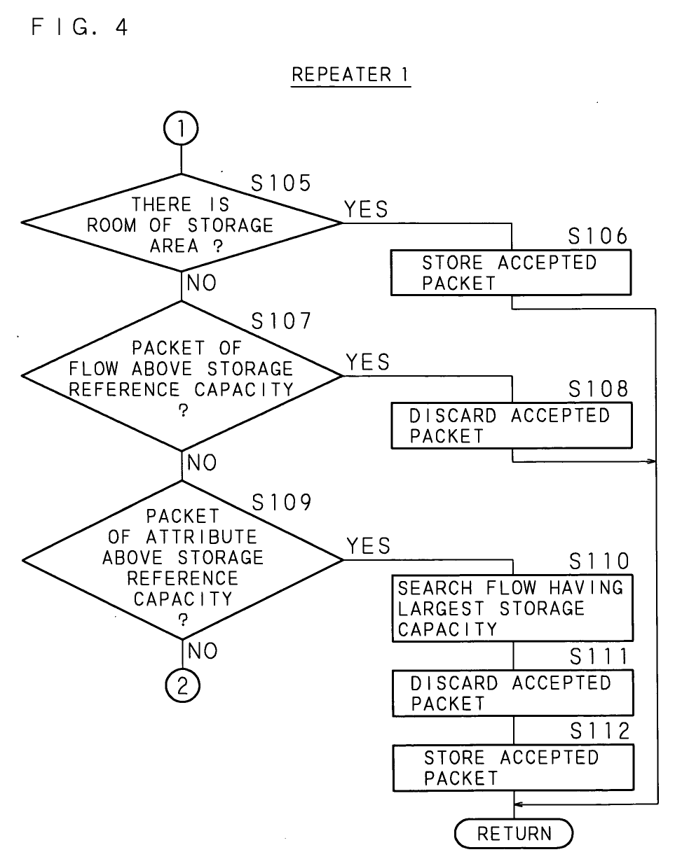

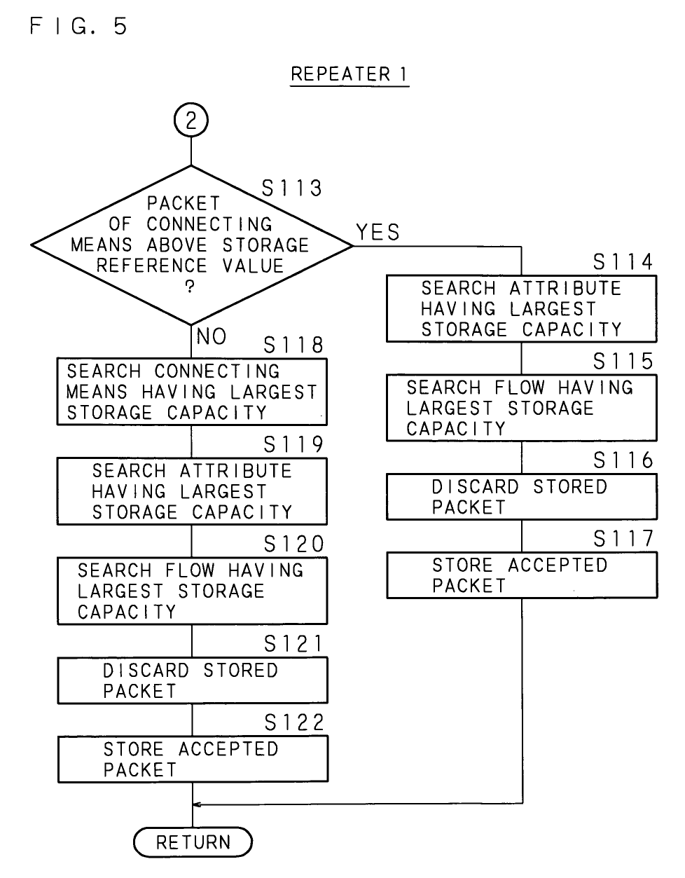

Next, each kind of processing of the repeater 1 in the embodiment 1 will be explained. FIG. 3, FIG. 4 and FIG. 5 are flowcharts showing a packet acceptance process of the repeater 1 in the embodiment 1 of the present invention. The repeater 1 of the present invention receives transfer data transmitted to the receiver 200 such as a personal computer via the communication network NW from the transmitter 100 such as a server computer for providing image information, for example, and performs repeating operation to send out the transfer data to the communication network NW. The transfer data thus relayed is subjected to various processing such as transfer by a unit called packet corresponding to divided data which is divided into data of a prescribed length and has a header attached thereto, showing each kind of information related to the transfer. Note that the transfer data constituted by a series of a plurality of packets is called a flow. A field is provided in the header of the packet according to a prescribed rule. In the field, various information such as information showing the transmitter 100, information showing the receiver 200, information showing the route, information showing the flow (transfer data) constituted by the packet, sequence information showing an order in the flow of the divided data included in the packet, information showing an attribute related to the transfer rate, information showing the target value of the transfer rate, total delay time information showing the target value of the delay time from the transmitter 100 to the receiver 200, and remaining delay time information showing the target value of the delay time from its own device to the receiver 200.

In the repeater 1 of the present invention, the packet constituting the flow of the transfer data transmitted to the receiver 200 via the communication network NW is received from the transmitter 100 by the connecting means 130 (S101), and the packet thus received is transferred to the route determination circuit 110.

In the route determination circuit 110 provided in the repeater 1 of the present invention, by a control of the controlling means 111, transmission destination information such as an IP address showing the receiver 200 shown in the prescribed field provided in the header of the packet is read, a transfer route in the communication network NW up to the receiver 200 shown by the transmission destination information thus read is determined (S102), the information showing the transfer route thus determined is written in the prescribed field provided in the header of the packet, and this packet is transferred to the control circuit 120.

The control circuit 120 provided in the repeater 1 of the present invention reads each kind of information shown in the prescribed field provided in the header of the packet accepted from the route determination circuit 110, and temporarily stores the packet in the temporary memory 122a. Then, by the control of the controlling means 121, the control circuit 120 determines for the accepted packet whether or not the sending time intervals and the storage capacity reference value (buffer size) of the packet to be sent out to the communication network NW is set (S103), and when it determines that the sending time intervals and the storage capacity reference value are not set (S103: NO), performs setting of the sending time intervals and the storage capacity reference value (S104). Note that when it is determined that the sending time intervals and the storage capacity reference value are set in step S103 (S103: YES), the process shown in step S104 is not performed. The sending time intervals and the storage capacity reference value are set by a flow unit constituting the packet. Therefore, the packet whose sending time intervals and whose storage capacity reference value are not set in step S103 is the packet which has not received the other packet constituting the same flow before, that is, the packet firstly received out of the packets constituting the flow. Also, the storage capacity reference value is a value showing a minimal usable storage capacity set for the packet of the corresponding flow. When the storage capacity of the packet stored in the buffer memory 122b is under the storage capacity reference value, the packet newly accepted is stored in the buffer memory 122b unconditionally. However, when the storage capacity of the packet stored in the buffer memory 122b exceeds the storage capacity reference value, the reference value of the storage capacity of the packet newly accepted is used as a criterion for deciding discard of the packet. Specifically, under an environment of low use rate of the buffer memory 122b, the use of the buffer memory 122b is allowed. However, by transiting to a high load environment and when the buffer memory 122b becomes full, there is a possibility of discarding the accepted packet.

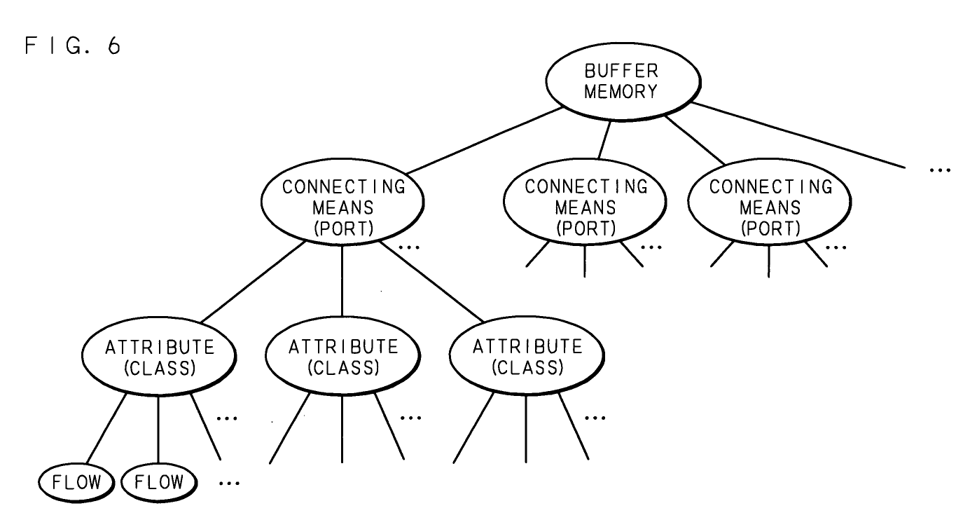

Here, a management of the buffer memory 122b of the control circuit 120 provided in the repeater 1 of the present invention will be explained. FIG. 6 is a conceptual view showing a hierarchical management of the packet of the repeater 1 in the embodiment 1 of the present invention. The storage area of the buffer memory 122b of the storing means 122 provided in the control circuit 120 of the present invention is shared by a plurality of connecting means (ports) 130, 130, . . . , and each of the connecting means 130, 130, . . . is used in transmission/reception of the flow of various attributes (classes). The attribute specified here shows a priority order of band usage, and specifically there are examples of attributes such as a band guaranteed type class guaranteeing the transfer rate, a best effort type class wherein the transfer rate changes depending on a traffic condition of the communication network NW. That is, the storage area of the buffer memory 122b is distributed into a plurality of connecting means 130, 130, . . . . The storage area of the buffer memory 122b distributed into each connecting means 130, 130, . . . is distributed to each attribute of the connecting means 130, 130, . . . . The hierarchical management is performed, so that the storage area of the buffer memory 122b distributed to each attribute is distributed to each flow of each attribute. In addition, the storage capacity reference value is set for each flow in accordance with a state, and the storage capacity reference value previously fixed or changeable as needed is set for each attribute and each connecting means 130, 130, . . . . It should be noted that the present invention has an excellent effect by being applied to the control to the flow particularly belonging to the band guaranteed type class.

An explanation is returned to the flowchart. By the control of the controlling means 121, the control circuit 120 provided in the repeater 1 of the present invention determines whether or not there is a room for storing the newly accepted packet in the storage area of the buffer memory 122b (S105), and when it determines that there is a room (S105: YES), stores the accepted packet in the buffer memory 122b (S106), and a packet acceptance process is ended.

In step S105, when it is determined that there is no room for storing the packet, namely, the buffer memory 122b is in a full state (S105: NO), by the control of the controlling means 121, the control circuit 120 determines whether or not the accepted packet is the packet constituting the flow using the buffer memory 122b above the storage capacity set by the storage capacity reference value (S107).

In step S107, when the accepted packet is determined to be the packet constituting the flow using the buffer memory 122b above the storage capacity set by the storage capacity reference value (S107: YES), the control circuit 120 discards the accepted packet by the control of the controlling means 121 (S108), and the packet acceptance process is ended.

When the accepted packet is determined not to be the packet constituting the flow using buffer memory 122b above the storage capacity set by the storage capacity reference value (S107: NO), by the control of the controlling means 121, the control circuit 120 determines whether or not the storage capacity concerning the attribute (class) attached to the flow constituted by the accepted packet exceeds the reference value of the storage capacity previously set (S109).

In step S109, when the storage capacity about the attribute is determined to exceed the reference value of the storage capacity previously set (S109: YES),), by the control of the controlling means 121, the control circuit 120 searches the flow out of each flow attached with attribute, which has a largest storage capacity capable of storing the packet in a buffer memory above each storage capacity reference value set for the flow (S110). Then, by the control of the controlling means 121, the control circuit 120 applies processing to the packet to be sent out firstly out of the packets constituting the searched flow, such as Pushout process to overwrite the accepted packet, namely, the process of discarding the packet to be firstly sent out (S111) and storing the accepted packet (S112), and then the packet acceptance process is ended.

In step S109, when the storage capacity concerning the attribute is determined not to exceed the storage capacity reference value previously set (S109: NO), by the control of the controlling means 121, the control circuit 120 determines whether or not the storage capacity concerning the connecting means 130 (ports) corresponding to the flow of the accepted packet exceeds the reference value of the storage capacity previously set (S113).

In step S113, when the storage capacity concerning the connecting means 130 is determined to exceed the storage capacity reference value previously set (S113: YES), by the control of the controlling means 121, the control circuit 120 searches the attribute out of each attribute attached to the flow corresponding to the connecting means 130, which has a largest storage capacity capable of storing the packet in the buffer memory above each reference vale of storage capacity set for the attribute (S114), and searches the flow out of each flow attached with the searched attribute, which has a largest storage capacity capable of storing the packet in the buffer memory above each storage capacity reference value set for the flow (S115). Then, by the control of the controlling means 121, the control circuit 120 applies processing to the packet to be firstly sent out constituting the searched flow, such as Pushout process to overwrite the accepted packet, namely, the process of discarding the packet to be firstly sent out (S116) and storing the accepted packet (S117), and the packet acceptance process is ended.

In step S113, when the storage capacity concerning the connecting means 130 is determined not to exceed the reference value of the storage capacity previously set (S113: NO), by the control of the controlling means 121, the control circuit 120 searches the connecting means 130 out of each of the shared connecting means 130, 130, . . . , which has a largest storage capacity capable of storing the packet in the buffer memory 122b having storage area shared by the connecting means 130 corresponding to the flow of the accepted packet, above each storage capacity reference value set for the connecting means 130, 130, . . . (S118), searches the attribute out of each attribute attached to the flow corresponding to the searched connecting means 130, which has a largest storage capacity capable of storing the packet in the buffer memory 122b above each storage capacity reference value set for the attribute (S119), and searches the flow out of each flow attached with the searched attribute, which has a largest storage capacity capable of storing the packet in the buffer memory 122b above each storage capacity reference value set for the flow (S120). Then, by the control of the controlling means 121, the control circuit 120 applies each processing to the packet to be firstly sent out, out of the packets constituting the searched flow, such as Pushout process of overwriting the accepted packet, namely, process of discarding the packet to be firstly sent out (S121) and storing the accepted packet (S122), and then the packet acceptance process is ended.

In this way, in the packet acceptance process of the repeater 1, discard of the accepted packet and the stored packet is judged based on the storage capacity reference value and the capacity of the packet stored in the buffer memory 122b of the storing means 122, and the process of discarding and storing the packet based on a determination result is executed.

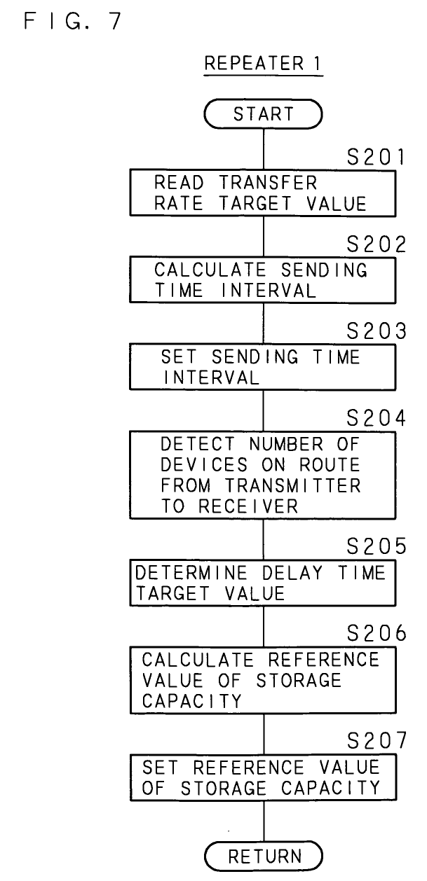

Next, the process of setting the sending time intervals and the storage capacity reference value executed in step S104 will be explained. FIG. 7 is a flowchart showing the process of calculating the sending time intervals and the storage capacity reference value of the repeater 1 in the embodiment 1 of the present invention. By the control of the controlling means 121, the control circuit 120 provided in the repeater 1 of the present invention reads the target value of the transfer rate shown as a header in the packet constituting the flow which is an object of calculation of the sending time intervals and the storage capacity reference value (S201), and based on the target value of the transfer rate thus read and a data length of the divided data included in the packet, the sending time intervals for sending out the packet to the communication network NW are calculated (S202), and the sending time intervals thus calculated are set as the sending time intervals of the packet constituting the flow (S203). The target value of the transfer rate thus read in step S201 indicates, for example, a band to be guaranteed for the packet belonging to the band guaranteed type, namely, a guaranteed value of the transfer rate. In addition, the transferred packet includes the divided data obtained by dividing the transfer data to be transferred from the transmitter 100 to the receiver 200 into a prescribed data length, and the data length of the divided data in step S202 indicates the prescribed data length previously set. Note that total data capacity of the transfer data does not necessarily become equal to an integer multiple of the prescribed data length, and therefore the data length of the divided data actually included in the packet may be smaller than the already set prescribed data length.

Then, by the control of the controlling means 121, the control circuit 120 provided in the repeater 1 of the present invention detects the number of devices (the number of hops) to be passed through by the packet to be transferred on the route in the communication network NW from the transmitter 100 to the receiver 200 (S204), and by dividing the time shown by total delay time information shown as a header in the packet by the number thus detected, the target value of the delay time required for the repeating operation of the packet is determined (S205). Detection of the number of devices in step S204 is realized by functions such as a function defined as RSVP and a traceroute function to detect the device to be passed through up to a particular device in the communication network NW.

Then, by the control of the controlling means 121, the control circuit 120 provided in the repeater 1 of the present invention calculates the reference value of the storage capacity of the packet constituting the flow to be stored in the buffer memory 122b of the storing means 122, based on the determined target value of the delay time and the calculated sending time intervals (S206), and the reference value of the storage capacity thus calculated is set as the storage capacity reference value allocated to the flow, which becomes a determination reference of discarding the packet that constitutes the flow (S207).

The aforementioned calculation process of sending time interval and the storage capacity reference value can be explained by using the following equation. When the target value of the transfer rate read in step S201 is identified as R, and the data length of the divided data is identified as D, the sending time interval τ calculated in step S202 can be shown by the following equation 1.

τ=R·×D Equation 1

where, τ: sending time interval
R: transfer rate target value
D: data length of divided data

Further, when the number of devices detected in step S204 is identified as n, and the time shown by the total delay time information is identified as To, the target value T of the delay time determined in step S205 can be shown by the following equation 2.

T=To/n Equation 2

Where, T: delay time target value
To: total delay time
n: the number of devices to be passed through on a route in communication network NW from transmitter 100 to receiver 200 (the number of hops)

Then, in step S206, as shown in the following equation 3, by dividing the delay time target value calculated by equation 2 by the sending time interval τ calculated by the equation 1, reference value β of storage capacity can be calculated.

β=T/τ Equation 3

Also, as shown by the following equation 4 based on the equation 2 and the equation 3, in the repeater 1 of the present invention, by sending out the packet based on the storage capacity reference value β and the sending time interval τ thus set, the total delay time To, that is, the delay time from End to End can be guaranteed.

To=n×β×τ Equation 4

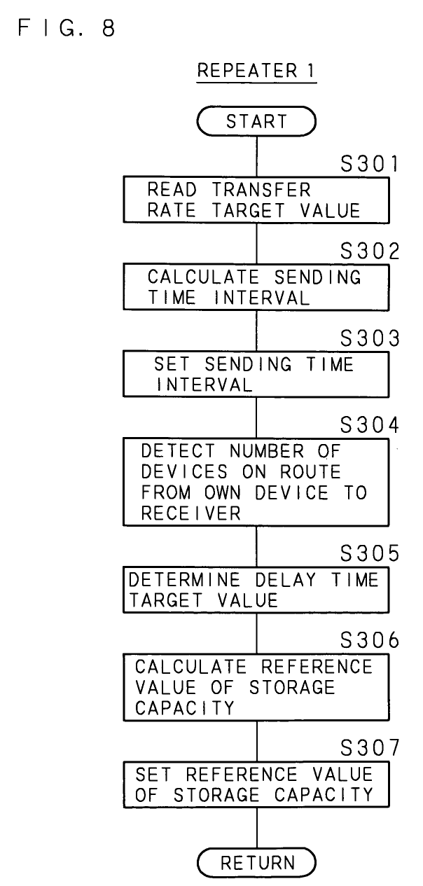

It should be noted that the storage capacity reference value and the sending time interval are not calculated based on the total delay time from the transmitter 100 to the receiver 200, but the storage capacity reference value and the sending time interval may be calculated based on the remaining delay time showing the target value of the delay time from its own device to the receiver 200. FIG. 8 is a flowchart showing the sending time interval and the storage capacity reference value based on the remaining delay time of the repeater 1 in the embodiment 1 of the present invention. By the control of the controlling means 121, the control circuit 120 provided in the repeater 1 of the present invention reads the target value of the transfer rate shown as a header in the packet constituting the flow, which is an object of calculation of the sending time intervals and the storage capacity reference value (S301), and based on the divided data included in the target value of the transfer rate thus read and the data length of the divided data included in the packet, the sending time interval for sending out the packet to the communication network NW is calculated (S302), and the sending time interval thus calculated is set as the sending time interval of the packet constituting the flow (S303).

By the control of the controlling means 121, the control circuit 120 provided in the repeater 1 of the present invention detects the number of devices to be passed through by the packet to be transferred on the route in the communication network NW from its own device to the receiver 200 (S304), and by dividing the time shown by the remaining delay time information shown as the header in the packet, determines the target value of the delay time required for the repeating operation of the packet (S305).

Then, by the control of the controlling means 121, the control circuit 120 provided in the repeater 1 of the present invention calculates the reference value of the storage capacity of the packet constituting the flow, which is stored in the buffer memory 122b of the storing means 122, based on the determined delay time target value and the calculated sending time interval (S306), and the calculated reference value of the storage capacity is set as the storage capacity reference value allocated to the flow (S307).

In this way, by calculating the sending time interval and the storage capacity reference value based on the remaining delay time information, the setting of the storage capacity reference value and the sending time interval is dynamically changed in accordance with the change of a delay state due to abnormalities caused at a transfer medium constituting the communication network NW such as a communication line and devices to be passed through from the transmitter 100 to the reception by its own device via the communication network NW, and increase in traffic. Therefore, the delay time and the transfer rate can be guaranteed even on the occurrence of a fault in the communication network NW.

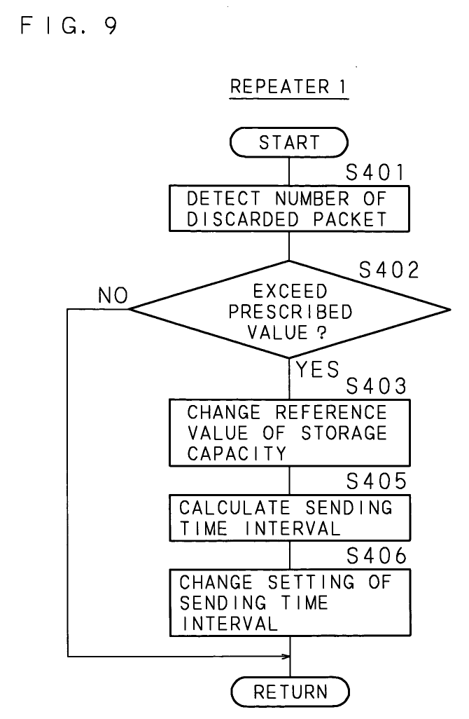

Moreover, the sending time interval and the storage capacity reference value already set once is not fixed, but can be dynamically changed in accordance with increase/decrease of the packet to be processed. FIG. 9 is a flowchart showing a setting changing process of the sending time interval and the storage capacity reference value of the repeater 1 in the embodiment 1 of the present invention. By the control of the controlling means 121, the control circuit 120 provided in the repeater 1 of the present invention detects the number of packets discarded without being sent out to the communication network NW in a prescribed period of time previously set (S401), and determines whether or not the number thus detected exceeds a prescribed value (S402). A detection process in step S401 is performed at prescribed time intervals. Then, every time the packet is discarded, the number thus discarded is calculated, and the control circuit 120 may determine whether or not the total of the number thus calculated every time the packet is discarded exceeds a prescribed value. The setting of the prescribed value may be set by any unit of the flow, attribute, and connecting means 130.

When the number of the discarded packets detected in step S402 is determined to exceed the prescribed value (S402: YES), the setting of the storage capacity reference value is changed following a prescribed rule (S403), the sending time interval is calculated based on the changed storage capacity reference value and delay time target value (S404), and the setting of the sending time interval is changed to the value thus calculated (S405). Further, in step S402, when the number of the discarded packets thus detected is determined not to exceed the prescribed value (S402: NO), the processing after step S403 is not performed. In the rule of changing the setting in step S403, it is possible to suitably set the storage capacity reference value such as increase in a prescribed capacity of the storage capacity, increase by a prescribed ratio. Also, the storage capacity for increase may be changed in accordance with the number of discarded packets above a prescribed value. The calculation of the sending time interval in step S404 is performed by using the following equation 5 which is obtained by deforming the equation 3, for example.

τ=T/B Equation 5

In this way, even when the number of packets to be processed by the repeater 1 is increased by the change of external circumstances such as an increase in traffic, the discarded packets are reduced and the delay time can be guaranteed by changing the setting in such a way that the storage capacity reference value is automatically set at large, and the sending time interval is set short.

By the aforementioned each kind of processing, the packet received by the repeater 1 of the present invention and stored in the buffer memory 122b of the control circuit 120 is read from the buffer memory 122b at the sending time intervals set for each flow and transferred to the connecting means 130, and sent out to the communication network NW from the connecting means 130 on the route determined by the route determination circuit 110. Note that the sending time intervals thus set show a maximum sending time interval, and therefore the packet may be sent out at the time intervals shorter than the set sending time intervals. Also, when the packet is sent out, each kind of information such as remaining delay information recorded in the header of the packet is rewritten.

The embodiment 1 describes such that by determining the sending time intervals and the storage capacity reference value for the packet having determined route to be sent out, the control circuit 120 having a QoS function to guarantee the delay time and the transfer rate is previously incorporated into the repeater 1. However, the present invention is not limited to this embodiment, and by incorporating the control circuit 120 of the present invention, which is a VLSI (Very Large Scale Integration) chip, into a conventional router device which performs only route determination processing, the conventional router device may be used as the repeater 1 of the present invention. In this case, the storing means 122 used as the buffer memory 122b may use a part of the storage area of the storing means 112 of the route determination circuit previously provided in the repeater 1 as the buffer memory 122b, without using the storing means 122 incorporated in the control circuit 120.

Also, according to the embodiment 1, as shown in FIG. 1, the devices in the communication network NW to be passed through from the transmitter 100 to the receiver 200 are all provided in the form of repeaters 1, 1, . . . of the present invention, but the present invention is not limited to this embodiment. For example, if the communication network NW has a design of high quality and small loss, only the device called an end node directly connected to the transmitter 100 and the receiver 200 may serve as the repeaters 1, 1 of the present invention. An embodiment of defining only the end node as the repeaters 1, 1 of the present invention will be explained hereunder.

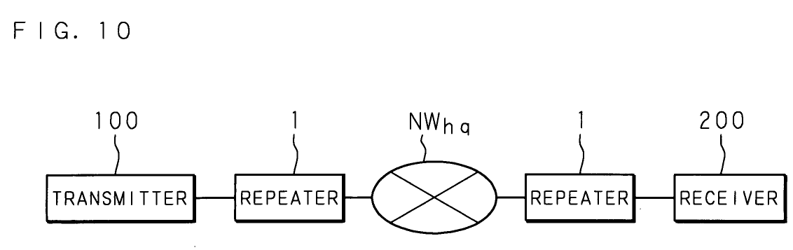

FIG. 10 is a block diagram showing a constitution of the communication system of the present invention. In FIG. 10, the repeaters 1, 1 of the present invention are directly connected to the transmitter 100 and the receiver 200, and connection is made between the repeaters 1, 1 by a high quality communication network NWhq such as an optical communication network using a route determination technique such as GMPLS (Generalized Multi-Protocol Label Switching). In the high quality communication network NWhq, a signal loss is small and the delay time is extremely short. Therefore, the function to guarantee the delay time as shown in the embodiment 1 can be realized, by selecting only end node as the repeaters 1, 1 of the present invention, and by executing the process explained in the embodiment 1 and the calculation process of the sending time interval and the storage capacity reference value based on the remaining delay time explained by particularly using FIG. 8, and the setting changing process of the sending time interval and the storage capacity reference value of the repeater 1 explained by using FIG. 9. Further, if it is possible to synchronize the time of the repeaters 1, 1, the delay time may be set by showing an arrival target time in the packet by the repeater 1 connected to the transmitter 100, based on the arrival target time shown in the packet by the repeater 1 connected to the receiver 200.

### Embodiment 2

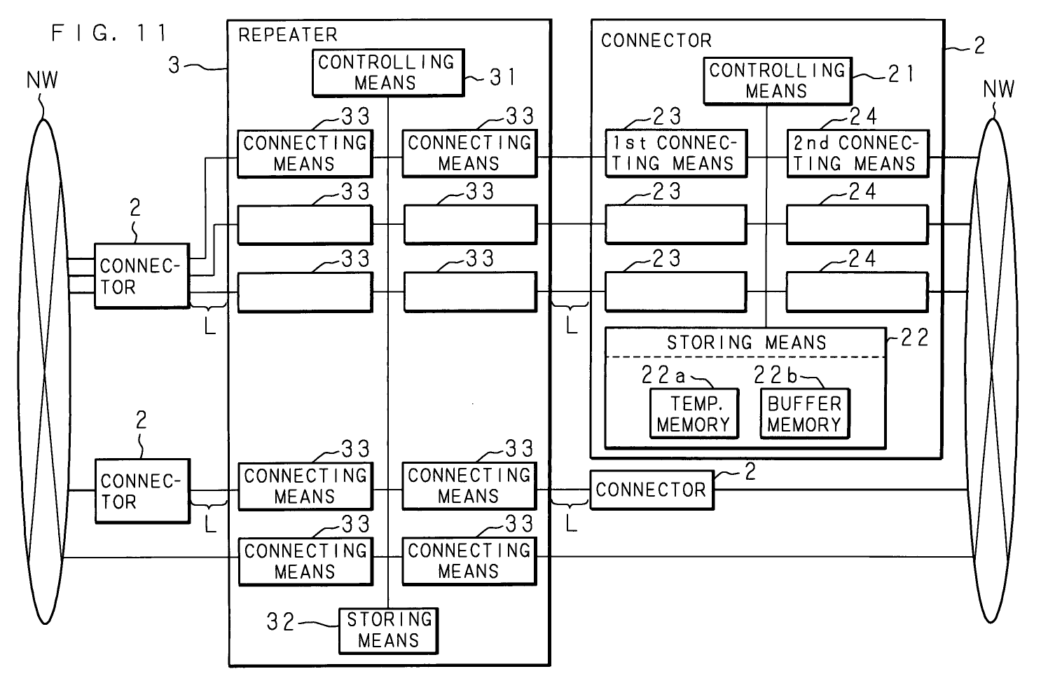

FIG. 11 is a block diagram showing the connector and the repeater having the connector connected thereto according to the embodiment 2 of the present invention. In FIG. 11, connectors of the present invention are identified as reference numerals 2, 2. The connector 2 is connected to a repeater 3 such as an internet router device which receives the packet to be transmitted from the device of sender to the device of receiver via the communication network NW, and having a route determining function to determine the route in the communication network NW for transmitting the received packet, via communication line L such as cable for Ethernet (registered trademark).

The connector 2 comprises the controlling means 21 such as a CPU, the storing means 22 such as a RAM, first connecting means 23, 23, . . . connected to, and the repeater 3, via communication line L, and second connecting means 24, 24, . . . connected to the communication network NW. Then, by the control of the controlling means 21, the connector 2 receives the packet having a route determined by the repeater 3, from the first connecting means 23, reads each kind of information, shown in a prescribed field provided in the header of the received packet, such as transmission destination information, information showing the route, information showing an attribute related to the transfer rate, and the target value of the transfer rate, and based on the information thus read, stores the packet in the storing means 22, and performs the processing of sending out the packet to the communication network NW by the route based on the information showing the route from the second connecting means 24. Also, the connector 2 transmits the packet received from the second connecting means 24, 24, . . . via the communication network NW to the repeater 3 from the first connecting means 23, 23, . . . via the communication line L.

The storage area of the storing means 22 is used as the temporary memory 22a for temporarily storing the packet received from the repeater 3 and as the buffer memory 22b for storing the packet temporarily stored in the temporary memory 22a for each flow, and is used commonly for storing each packet sent out from each of a plurality of second connecting means 24, 24, . . . .

The repeater 3 comprises a controller 31 such as a CPU, storing means 32 such as a RAM, and connecting means 33, 33, . . . connected to the connectors 2, 2, . . . via the communication line L. Then, by the control of the controller 31, the repeater 3 temporarily stores the packet received by the connecting means 33 in the storing means 32, and based on the transmission destination information such as an IP address showing the device of receiver shown in a prescribed field provided in the header of the packet, determines the route in the communication network NW, and by attaching the information showing the determined route to the packet, transmits the packet to an appropriate connector 2 according to the route. Note that the repeater 3 can also be directly connected to the communication network NW via the connecting means 33, 33, . . . . However, in this case, the processing to guarantee the transfer rate and the delay time as will be described later is not applied to the packet which is directly sent out to the communication network NW from the connecting means 33, 33, . . . . In addition, one connector 2 may be connected to one repeater 3.

In this way, according to the embodiment 2, by connecting the connectors 2, 2, . . . to the conventional repeater 3 not having the QoS function, the same processing as that of the repeater 1 of the embodiment 1 of the present invention is realized, wherein the connectors 2, 2, . . . perform operation corresponding to the control circuit 120, and the repeater 3 performs operation corresponding to the route determination circuit 110 of the embodiment 1.

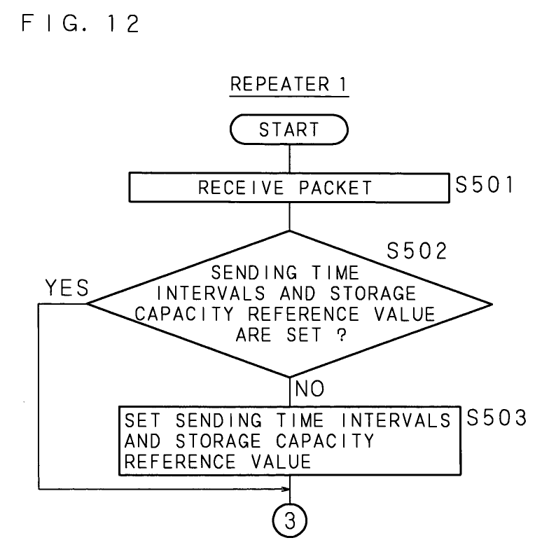

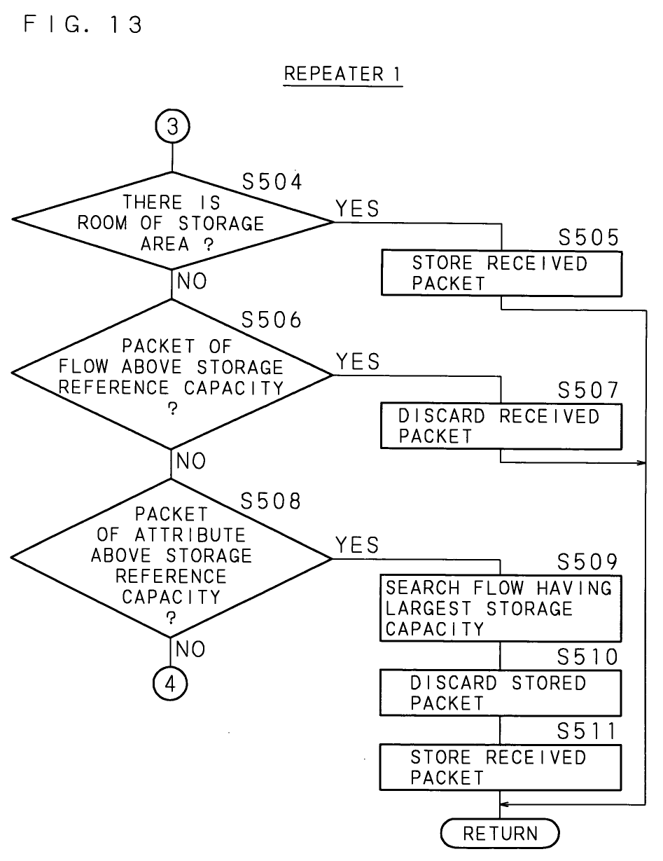

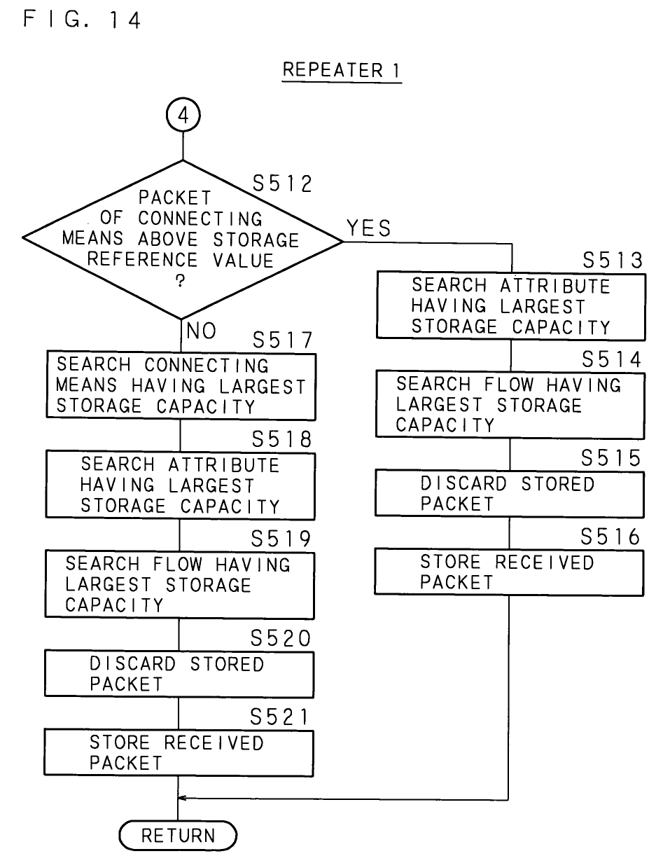

Next, each kind of processing of the connector 2 according to the embodiment 2 of the present invention will be explained. FIG. 12, FIG. 13, and FIG. 14 are flowcharts showing a packet reception processing of the connector 2 according to an embodiment 2 of the present invention. By the control of the controlling means 21, the connector 2 of the present invention receives the packet transmitted from the repeater 3 via the communication line L by the first connecting means 23 (S501), reads each kind of information shown in a prescribed field provided in the header of the packet thus received, and temporarily stores the packet in the temporary memory 22a. Then, by the control of the controlling means 21, the connector 2 determines whether or not the sending time intervals for sending out the packet to the communication network NW and the storage capacity reference value of the packet are set for the packet (S502), and when the sending time intervals and the storage capacity reference value are determined not to be set (S502: NO), the processing of setting the sending out time and the storage capacity reference value is performed (S503). Note that in step S502, when the sending time intervals and the storage capacity reference value are determined to be set (S502: YES), the processing shown in step S503 is not performed.

Then, by the control of the controlling means 21, the connector 2 of the present invention determines whether or not there is a room of storing the newly received packet in the storage area of the buffer memory 22b (S504), and when it determines that there is a room of storing the packet (S504: YES), it stores the received packet in the buffer memory 22b (S505), and the packet reception process is ended.

When it is determined that there is no room of storing the packet in step S504 (S504: NO), by the control of the controlling means 21, the connector 2 determines whether or not the received packet is the packet constituting the flow using the buffer memory 22b above the storage capacity set by the storage capacity reference value (S506).

In step S506, when it is determined that the received packet is the packet constituting the flow using the buffer memory 22b above the storage capacity set by the storage capacity reference value (S506: YES), by the control of the controlling means 21, the connector 2 discards the received packet (S507) and the packet reception process is ended.

In step S506, when it is determined that the received packet is not the packet constituting the flow using the buffer memory 22b above the storage capacity set by the storage capacity reference value (S506: NO), by the control of the controlling means 21, the connector 2 determines whether or not the storage capacity concerning the attribute attached to the flow constituted by the accepted packet exceeds the reference value of the storage capacity previously set (S508).

In step S508, when it is determined that the storage capacity concerning the attribute exceeds the reference value of the storage capacity previously set (S508: YES), by the control of the controlling means 21, the repeater 2 searches the flow out of each flow attached with the attribute, which has the largest storage capacity capable of storing the packet above each storage capacity reference value set for the flow (S509). Then, by the control of the controlling means 21, the connector 2 discards the packet out of the packets constituting the searched flow, which has to be firstly sent out (S510) and performs Pushout processing of storing the received packet (S511), and the packet reception process is ended.

In step S508, when it is determined that the storage capacity concerning the attribute does not exceed the reference value of the storage capacity previously set (S508: NO), by the control of the controlling means 21, the connector 2 determines whether or not the storage capacity concerning the second connecting means 24 corresponding to the flow of the accepted packet exceeds the reference value of the storage capacity previously set (S512).

In step S512, when it is determined that the storage capacity concerning the second connecting means 24 exceeds the reference value of the storage capacity previously set (S512: YES), by the control of the controlling means 21, the connector 2 searches the attribute out of each attribute attached to the flow corresponding to the second connecting means 24, which has the largest storage capacity capable of storing the packet above each storage capacity reference value set for the attribute (S513), and searches the flow out of each flow attached with the searched attribute, which has the largest storage capacity capable of storing the packet above each storage capacity reference value set for the flow (S514). Then, by the control of the controlling means 21, the connector 2 discards the packet out of the packets constituting the searched flow, which is to be firstly sent out (S515), and performs Pushout processing of storing the received packet (S516), and the packet reception process is ended.

In step S512, when it is determined that the storage capacity concerning the second connecting means 24 does not exceed the reference value of the storage capacity previously set (S512: NO), by the control of the controlling means 21, the connector 2 searches the second connecting means 24 out of each of the shared second connecting means 24, 24, . . . , which has the largest storage capacity capable of storing the packet in the buffer memory 22b having the shared storage area by the second connecting means 24 corresponding to the flow of the accepted packet, above each storage capacity reference value set for the second connecting means 24, 24, . . . (S517), searches the attribute out of each attribute attached to the flow corresponding to the searched second connecting means 24, which has the largest storage capacity capable of storing the packet above each storage capacity reference value set for the attribute (S518), and searches the flow out of each flow attached with the searched attribute, which has the largest storage capacity capable of storing the packet above each storage capacity reference value set for the flow (S519). Then, by the control of the controlling means 21, the connector 2 discards the packet out of the packets constituting the searched flow, which is to be firstly sent out (S520) and performs Pushout processing of storing the received packet (S521), and the packet reception process is ended.

In this way, according to the packet reception process of the connector 2, discard of the received packet and stored packet is judged based on the storage capacity reference value set for the flow and the capacity of the packet stored in the buffer memory 22b of the storing means 22, and the processing of discarding and storing the packet is performed based on the determination result.

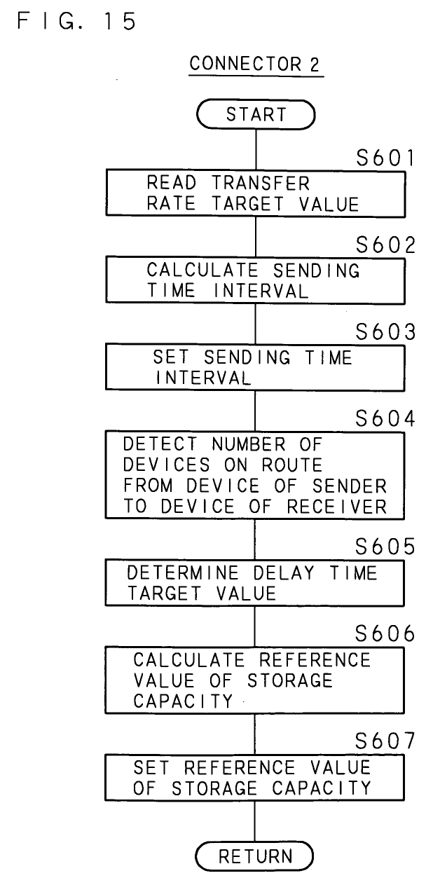

Next, the processing of setting the sending time intervals and the storage capacity reference value performed in step S503 will be explained. FIG. 15 is a flowchart showing the calculation process of the sending time intervals and the storage capacity reference value of the connector 2 according to the embodiment 2 of the present invention. By the control of the controlling means 21, the connector 2 of the present invention reads the target value of the transfer rate shown as the header of the packet constituting the flow, which is an object of calculation of the sending time interval and the storage capacity reference value (S601), and calculates the sending time interval for sending out the packet to the communication network NW, based on the read target value of the transfer rate and the data length of the divided data included in the packet (S602), and the sending time interval thus calculated is set as the sending time interval of the packet constituting the flow (S603).

By the control of the controlling means 21, the connector 2 of the present invention detects the number of devices to be passed through by the packet to be transferred in the communication network NW from the device of sender to the device of receiver (S604), and by dividing the time shown by the total delay time information shown as the header in the packet by the number thus detected, the target value of the delay time required for the repeating operation of the packet is determined (S605). Then, by the control of the controlling means 21, the connector 2 of the present invention calculates the reference value of the storage capacity of the packet constituting the flow for storing the packet in the buffer memory 22b of the storing means 22 (S606) based on the determined delay time target value and the calculated sending time intervals, and the storage capacity reference value thus calculated is set as the storage capacity reference value allocated to the flow, which is a determination reference of discarding the packet constituting the flow (S607).

Note that in the connector 2 according to the embodiment 2 of the present invention, the sending time intervals and the storage capacity reference value are not calculated based on the total delay time information, but the sending time intervals and the storage capacity reference value may be calculated based on the remaining delay time information. The calculation process of the sending time intervals and the storage capacity reference value based on the remaining delay time of the connector 2 according to the embodiment 2 of the present invention is the same as the calculation process of the sending time intervals and the storage capacity reference value based on the remaining delay time of the repeater 1 according to the embodiment 1 explained by using FIG. 8, and therefore the embodiment 1 is referred to and the explanation is omitted.

Further, in the connector 2 according to the embodiment 2 of the present invention, the sending time intervals and the storage capacity reference value already set once are not fixed but can be dynamically changed in accordance with the increase/decrease of the packet to be processed. The setting changing process of setting of the sending time interval and the storage capacity reference value of the connector 2 in the embodiment 2 of the present invention is the same as the setting changing process of the sending time intervals and the storage capacity reference value according to the embodiment 1 of the present invention explained by using FIG. 9, and therefore the embodiment 1 is referred to and the explanation is omitted.

By the aforementioned each kind of process, the packet stored in the buffer memory 22b provided in the connector 2 of the present invention is read from the buffer memory 22b at the sending time intervals set for each flow, which is then transferred to the second connecting means 24, and is sent out to the communication network NW from the second connecting means 24 on the determined route.

### Embodiment 3

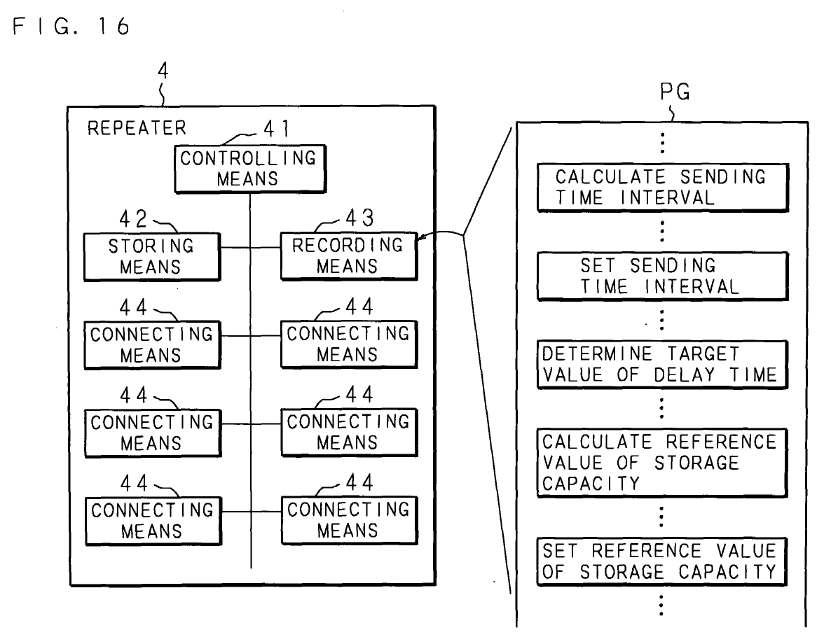

FIG. 16 is a block diagram showing the repeater according to an embodiment 3 of the present invention. Identified as reference numeral 4 in FIG. 16 is the repeater. The repeater 4 comprises a controlling means 41 such as a CPU, storing means 42 such as a RAM, recording means 43 such as a flush memory, and connecting means 44 connected to the communication network NW. A computer program PG of the present invention is recorded in the recording means 43 as firmware. The repeater 4 is a kind of computer such as an internet router device comprising a route determination function which is the function to receive the packet to be transmitted to the device of receiver from the device of sender via the communication network NW and determine the route in the communication network NW to transmit the received packet. The repeater 4 can realize the same function as that of the repeater 1 according to the embodiment 1 of the present invention, by reading the computer program PG of the present invention recorded in the recording means 43 and executing it by the controlling means 41.

In this way, according to the embodiment 3, the same function as that of the embodiment 1 of the present invention can be realized, by executing the computer program PG of the present invention as firmware by the conventional repeater 4 which does not have the QoS function. Note that each kind of process realized by executing the computer program PG of the present invention is substantially the same as the process of the control circuit 120 in the embodiment 1 of the present invention. Therefore, the embodiment 1 is referred to and the explanation for each kind of process is omitted.

According to the embodiments 1, 2 and 3, the storage capacity reference value and the sending time intervals are set for the packet belonging to the attribute of band guaranteed type, to guarantee the delay time. However, the present invention is not limited thereto, and can be applied to the packet of various attributes. Preferably in this case, for example, by performing the processing to the packet belonging to the attribute of best effort type, such as setting 30% of maximum value of the transfer rate as the target value of the transfer rate, the packet belonging to the attribute of best effort type is differentiated from the packet belonging to the attribute of band guaranteed type.

1-8. (canceled)

9. A repeater for receiving a packet, in which a target value of a transfer rate is shown including divided data obtained by dividing transfer data into a prescribed data length, determining a route in a communication network to send out the packet, storing the packet having a determined route in storing means, and sending out the packet stored in the storing means to the communication network by the determined route at set sending time intervals, comprising:
means for calculating the sending time intervals to send out the packet to the communication network, based on the target value of the transfer rate shown in the received packet and the data length of the divided data;
means for setting the sending time intervals thus calculated as the sending time intervals of the packet;
target value determining means for determining means for determining the target value of a delay time required for repeating the packet;
means for calculating a reference value of a storage capacity of the packet to be stored in the storing means, based on the delay time target value and the sending time intervals; and
means for determining the necessity of discarding the packet, based on the reference value of the storage capacity thus calculated and a capacity of the packet stored in the storing means.

10. The repeater as set forth in claim 9, further comprising:
means for detecting the number of discarded packets; and means for changing the setting of the storage capacity reference value and the sending time intervals, when the number of the packets thus detected exceeds a prescribed value.

11. The repeater as set forth in claim 9, wherein the received packet includes total delay time information showing the target value of the delay time from a sender to a receiver and,
the target value determining means detects the number of devices to be passed through on the route in the communication network from the sender to the receiver, and determines the target value of the delay time by dividing the time shown by the total delay time information included in the packet by the number thus calculated.

12. The repeater as set forth in claim 11, further comprising:
means for detecting the number of discarded packets; and means for changing the setting of the storage capacity reference value and the sending time intervals, when the number of the packets thus detected exceeds a prescribed value.

13. The repeater as set forth in claim 9, wherein the received packet includes remaining delay time information showing the target value of the delay time from its own device to the transmission destination, and
the target value determining means detects the number of devices to be passed through on the route in the communication network up to the transmission destination, and determines the target value of the delay time by dividing the time shown by the remaining delay time information included in the packet, by the number of the devices thus detected.

14. The repeater as set forth in claim 13, further comprising:
means for detecting the number of discarded packets; and
means for changing the setting of the storage capacity reference value and sending time intervals, when the number of the packets thus detected exceeds a prescribed value.

15. A communication system having a transmitter connected to a communication network and transmitting a packet, and a receiver receiving the packet transmitted from the transmitter, comprising:
a repeater connected to the communication network, and repeating the packet transmitted from the transmitter to the receiver, wherein
the repeater received a packet, in which a target value of a transfer rate is shown including divided data obtained by dividing transfer data into a prescribed data length, determines a route in a communication network to send out the packet, stores the packet having a determined route in storing means, and sends out the packet stored in the storing means to the communication network by the determined route at set sending time intervals, and comprises:
means for calculating the sending time intervals to send out the packet to the communication network, based on the target value of the transfer rate shown in the received packet and the data length of the divided data;
means for setting the sending time intervals thus calculated as the sending time intervals of the packet;
target value determining means for determining the target value of a delay time required for repeating the packet;
means for calculating a reference value of a storage capacity of the packet to be stored in the storing means, based on the delay time target value and the sending time intervals; and
means for determining the necessity of discarding the packet, based on the reference value of the storage capacity thus calculated and a capacity of the packet stored in the storing means.

16. The communication system as set forth in claim 15, wherein the repeater further comprises:
means for detecting the number of discarded packets; and
means for changing the setting of the storage capacity reference value and the sending time intervals, when the number of the packets thus detected exceeds a prescribed value.

17. The communication system as set forth in claim 15, wherein
the received packet includes total delay time information showing the target value of the delay time from a sender to a receiver, and
the target value determining means detects the number of devices to be passed through on the route in the communication network from the sender to the receiver, and determines the target value of the delay time by dividing the time shown by the total delay time information included in the packet by the number thus calculated.

18. The communication system as set forth in claim 11, wherein the repeater further comprises:
means for detecting the number of discarded packets; and
means for changing the setting of the storage capacity reference value and the sending time intervals, when the number of the packets thus detected exceeds a prescribed value.

19. The communication system as set forth in claim 15, wherein
the received packet includes remaining delay time information showing the target value of the delay time from its own device to the transmission destination, and
the target value determining means detects the number of devices to be passed through on the route in the communication network up to the transmission destination, and determines the target value of the delay time by dividing the time shown by the remaining delay time information included in the packet, by the number of the devices thus detected.

20. The communication system as set forth in claim 19, wherein the repeater further comprises:
means for detecting the number of discarded packets; and
means for changing the setting of the storage capacity reference value and the sending time intervals, when the number of the packets thus detected exceeds a prescribed value.

21. A control circuit, used in a repeater for reviving a packet, in which a target value of a transfer rate is shown including divided data obtained by dividing transfer data into a prescribed data length, determining a route in a communication network to send out the packet, and sending out the packet to the communication network by the route thus determined, for storing the packet having a determined route in storing means and sending out it to the communication network, comprising:
means for calculating the sending time intervals to send out the packet to the communication network, based on the target value of the transfer rate shown in the received packet and the data length of the divided data;
means for setting the sending time intervals thus calculated as the sending time intervals of the packet;
means for determining the target value of a delay time required for repeating the packet;
means for calculating a reference value of a storage capacity of the packet to be stored in the storing means, based on the delay time target value and the sending time intervals;
means for determining the necessity of discarding the packet based on the reference value of the storage capacity thus calculated and a capacity of the packet stored in the storing means; and
means for sending out the packet stored in the storing means form the repeater at set sending time intervals.

22. A connector having a first connecting means connected to a repeater to receive a packet in which a target value of a transfer rate is shown including divided data obtained by dividing transfer data into a prescribed data length, determine a route in a communication network to send out the packet and send out the packet having a determined route, and a second connecting means connected to the communication network, comprising:
storing means for storing the packet sent out to the communication network;
means for receiving the packet having the determined route from the repeater through the first connecting means;
means for calculating sending time intervals at which the packet is sent out to the communication network, based on a target value of the transfer rate shown in the received packet and a data length of divided data;
means for setting the sending time intervals thus calculated as the sending time intervals of the packet;
means for determining the target value of a delay time required for repeating the packet;
means for calculating a reference value of a storage capacity of the packet to be stored in the storing means, based on the delay time target value and the sending time intervals;
means for determining the necessity of discarding the packet, based on the reference value of the storage capacity thus calculated and a capacity of the packet stored in the storing means; and
means for sending out the packet stored in the storing means from the second connecting means to the communication network by the determined route at the set sending time intervals.

23. A computer program product for controlling a computer to receive a packet, in which a target value of a transfer rate is shown including divided data obtained by dividing transfer data into a prescribe data length, determine a route in a communication network to send out the packet, store the packet having a determined route in storing means to send out it to the communication network by a computer for sending out the packet to the communication network on the route, wherein the computer program product comprises:
a computer readable storage medium having computer readable program code means embodies in said medium, said computer readable program code means comprising computer instruction means for:
calculating time intervals to send out the packet to the communication network, based on the target value of the transfer rate shown in the received packet and the data length of the divided data;
setting sending time intervals thus calculated as the sending time intervals of the packet;
determining a target value of a delay time required for repeating the packet;
calculating a reference value of a storage capacity of the packet stored in the storing means, based on a delay time target value and the sending time intervals; and
setting the reference value of the storage capacity thus calculated as the storage capacity reference value, used as a criterion for deciding discard of the packet.
